(19) United States
(12) Patent Application Publication
(10) Pub. No.: US 2009/0118878 A1
(43) Pub. Date: May 7, 2009

(54) Method for controlling electric oil pump for hybrid electric vehicle

(75) Inventor: Young Kug Park, Gyeonggi-do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/228,201

(22) Filed: Aug. 11, 2008

(30) Foreign Application Priority Data
Nov. 5, 2007 (KR) 10-2007-0111876

(51) Int. Cl. B60L 11/00

(52) U.S. Cl. 701/22

(57) ABSTRACT

The present invention provides a method for controlling an electric oil pump for an HEV having an automatic transmission and capable of operating in an electric vehicle (EV) mode by a clutch between an engine and a drive motor, which can provide an efficient power control of the system and satisfy system requirements such as a rapid response with the operation of an external oil pump during initial start-up and during running of the vehicle.

For this purpose, the present invention provides a method for controlling an electric oil pump for a hybrid electric vehicle, the method including: turning on the electric oil pump when a current vehicle speed is less than a first reference vehicle speed C1, at which a mechanical oil pump in an automatic transmission provides a normal discharge amount, and a starter key is in an ignition on position IG ON; turning off the electric oil pump when the current vehicle speed is more than the first reference vehicle speed C1, at which the mechanical oil pump in the automatic transmission provides the normal discharge amount; and controlling the electric oil pump to be turned on at a second reference vehicle speed C2 between the first reference vehicle speed C1, which is a time point when the electric oil pump is turned on, and an engine idling state, and controlling the electric oil pump to be operated at a second speed (high speed) when the current vehicle speed is smaller than the second reference vehicle speed C2 and a wheel demand torque is smaller than a torque T3 at a time point that does not require a rapid response of a system.

### CROSS-REFERENCE TO RELATED APPLICATION

This application claims under 35 U.S.C. §119(a) the benefit of Korean Patent Application No. 10-2007-0111876 filed Nov. 5, 2007, the entire contents of which are incorporated herein by reference.

### BACKGROUND

(a) Technical Field

The present invention relates to a method for controlling an electric oil pump for a hybrid electric vehicle (HEV). More particularly, the present invention relates to a method for controlling an electric oil pump for an HEV having an automatic transmission and capable of operating in an electric vehicle (EV) mode by a clutch between an engine and a drive motor, which can provide an efficient power control of the system and satisfy system requirements such as a rapid response with the operation of an external oil pump during initial start-up and during running of the vehicle.

(b) Background Art

As shown in exemplary FIG. 1, a hybrid electric vehicle (HEV) can include an engine 10 and a drive motor 20 as driving power sources of the vehicle, an engine clutch 70 connecting the engine 10 and the drive motor 20, an integrated starter-generator 30 (ISG) for the operation of the engine 10 and the drive motor 20, and a high voltage battery (not shown). Not shown in the figure, a hybrid control unit (HCU), a motor control unit (MCU), a battery management system (BMS), and the like are also included as control means thereof.

A mechanical oil pump 50 is provided in an automatic transmission 40 and an external electric oil pump 60 is independently provided on the outside of the automatic transmission 40. In general, since an engine output shaft is connected to the mechanical oil pump 50 in the automatic transmission 40 in a mass-production vehicle (gasoline or diesel engine vehicle), the electric oil pump 60 is operated upon start-up of the engine to supply an appropriate amount of oil to the vehicle system.

The hybrid electric vehicle (HEV) having the above configuration may be driven in an electric vehicle (EV) mode, which is directed to a purely electric vehicle mode using the motor power only, a HEV mode, which is an auxiliary mode using the rotational force of the motor as an auxiliary power source with the use of the rotational force of the engine as a main power source, and a regenerative braking (RB) mode, in which braking energy or inertia energy of the vehicle produced by braking or during driving by inertia is recovered by power generation of the motor and charged in a battery.

Thus, during initial start-up, the HEV can be driven only by the drive motor in the EV mode in which the engine is turned off and the clutch between the engine and the drive motor is opened. Moreover, during initial start-up, the HEV can be driven by driving powers of the engine and the drive motor at the same time, i.e., in the HEV mode.

Meanwhile, in the HEV, the engine and an electric motor are connected to accessory units, respectively, and a starter motor for start-up of the engine and an external electric oil pump for supplying working oil to the transmission are included.

Preferably, during initial start-up of the vehicle in the EV mode, it is necessary to supply oil required for transmission control of the transmission and, during initial start-up of the vehicle in the HEV mode, it is also necessary to supply oil required for transmission control and engagement of the clutch between the engine and the drive motor. Accordingly, the electric oil pump 60 should preferably be provided in the HEV for these reasons.

The electric motor is referred to as the ISG 30 in which the start-up function and the generation function are integrated, and the starter motor performs a function of rotating a crankshaft during start-up of the engine, and the external electric oil pump 60 functions to supply working oil to the transmission and working oil supply passage according to the operation of the engine during an idle stop of the engine.

Since the external electric oil pump 60 of the hybrid system is operated at a vehicle speed lower than a predetermined level, a drive shaft of the electric oil pump 60 is connected to an output shaft of the engine to supply oil for lubrication to the transmission. Accordingly, when the vehicle is driven in the EV mode at low speed or in a creep drive mode in a state where the battery is fully charged, the engine is not driven and thus the operation of the oil pump is stopped.

U.S. Pat. No. 6,840,889 discloses a technique in which a motor-driven external oil pump is mounted in a soft (mile) HEV to provide oil pressure to a transmission or a starting clutch, the external oil pump being driven when the vehicle is in an idle stop state and the oil pressure in an oil passage is less than a predetermined value. The revolution rate of the oil pump is determined by a difference between the oil pressure in the oil passage and a target oil pressure. That is, when the current oil pressure is largely deviated from the target oil pressure, the current of the motor is controlled to increase the revolution rate, and the revolution rate of the oil pump is gradually increased as the difference in oil pressure is reduced. The above technique that uses a signal of an oil pressure sensor makes it possible to efficiently control the revolution rate of the oil pump; however, using this technique requires an expensive oil pressure sensor.

U.S. Patent Publication No. 20040038774 discloses a technique which drives an external oil pump, when an engine revolution rate is reduced below a predetermined value, to control oil pressure supplied to a clutch in a soft (mild) HEV. U.S. Patent Publication No. 20050178592 discloses a technique which drives an oil pump when a hydraulic pressure of a starting clutch is lower than a target hydraulic pressure in a soft (mild) HEV, the hydraulic pressure being estimated by a rotational speed of a drive motor or measured using a pressure sensor. U.S. Pat. No. 6,835,160 discloses a technique which engages a lockup clutch of a torque converter before entering a regenerative operation to increase the amount of regenerative braking in a hybrid vehicle. For this, a motor-driven oil pump is driven when the revolution rate of an engine is decreased within a predetermined range during deceleration of the vehicle to produce oil pressure for controllably operating the lockup clutch of the torque converter.

The above described electric oil pump 60 uses electric power of the battery (of high or low voltage) mounted in the vehicle as a power source, and thus it is necessary to provide an efficient power control of the system and satisfy system requirements such as a rapid response by supplying a sufficient amount of oil to the transmission and the engine clutch in case of a quick start after a vehicle stop.

The above information disclosed in the Background section is only for enhancement of understanding of the background of the invention and therefore it may contain information that does not form the prior art that is already known in this country to a person of ordinary skill in the art.

### SUMMARY OF THE DISCLOSURE

In one aspect, the present invention is directed to a method for controlling an electric oil pump for a hybrid electric vehicle, which can provide an efficient power control of the system by selectively controlling an electric oil pump, which preferably uses electric power of a battery (of high or low voltage) mounted in the vehicle as a power source, at a first speed or a second speed according to a vehicle speed and an oil temperature, and satisfy system requirements such as a rapid response by preferably supplying a sufficient amount of oil to a transmission and an engine clutch in case of a quick start after a vehicle stop.

In one embodiment, the present invention provides a method for controlling an electric oil pump for a hybrid electric vehicle, the method comprising turning on the electric oil pump when a current vehicle speed is less than a first reference vehicle speed C1, at which a mechanical oil pump in an automatic transmission provides a normal discharge amount, and a starter key is in an ignition on position IG ON; turning off the electric oil pump when the current vehicle speed is more than the first reference vehicle speed C1, at which the mechanical oil pump in the automatic transmission provides the normal discharge amount; and controlling the electric oil pump to be turned on at a second reference vehicle speed C2 between the first reference vehicle speed C1, which is preferably a time point when the electric oil pump is turned on, and an engine idling state, and controlling the electric oil pump to be operated at a suitable second speed (high speed) when the current vehicle speed is smaller than the second reference vehicle speed C2 and a wheel demand torque is smaller than a torque T3 at a time point that does not require a rapid response of a system.

In a preferred embodiment, the electric oil pump is controlled to be operated at a suitable first speed (low speed) when the current vehicle speed is equal to the second reference vehicle speed C2 and preferably the wheel demand torque is lower than the torque T3.

In another preferred embodiment, the electric oil pump is controlled to be turned off when a predetermined time Tt is passed in a state where a driver does not suitably operate the starter key in the ignition on position IG ON toward a start position ST.

In still another preferred embodiment, the electric oil pump is controlled to be driven at the first speed when the starter key is turned to the start position ST by the driver after the predetermined time Tt.

In yet another preferred embodiment, a control for compensating for a rotational speed of the electric oil pump is performed with a compensation coefficient according to an oil temperature by detecting the oil temperature discharged from the electric oil pump, in which a compensation control for increasing the rotational speed of the electric oil pump is performed when the oil temperature is detected to be suitably lower than a reference temperature, and a compensation control for reducing the rotational speed of the electric oil pump or turning off the electric oil pump is performed when the oil temperature is more than the reference temperature.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a configuration diagram of a hybrid electric vehicle.

FIG. 2 is a graph illustrating a basic concept of a method for controlling an electric oil pump for a hybrid electric vehicle in accordance with the present invention with respect to a vehicle speed and a wheel demand torque.

FIG. 3 is a flowchart illustrating the method for controlling an electric oil pump for a hybrid electric vehicle in accordance with the present invention.

FIG. 4 is a diagram of a control algorithm illustrating the method for controlling an electric oil pump for a hybrid electric vehicle in accordance with the present invention.

Reference numerals set forth in the Drawings includes reference to the following elements as further discussed below:

10: engine

20: drive motor

30: ISG

40: automatic transmission

50: mechanical oil pump

60: electric oil pump

70: engine clutch

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

As described herein, the present invention includes a method for controlling an electric oil pump for a hybrid electric vehicle, the method comprising turning on the electric oil pump when a current vehicle speed is less than a first reference vehicle speed C1, at which a mechanical oil pump in an automatic transmission provides a normal discharge amount, and a starter key is in an ignition on position IG ON, and turning off the electric oil pump when the current vehicle speed is more than the first reference vehicle speed C1, at which the mechanical oil pump in the automatic transmission provides the normal discharge amount.

In preferred embodiments, the method further comprises controlling the electric oil pump to be turned on at a second reference vehicle speed C2 between the first reference vehicle speed C1, which is a time point when the electric oil pump is turned on, and an engine idling state, and controlling the electric oil pump to be operated at a second speed (high speed) when the current vehicle speed is smaller than the second reference vehicle speed C2 and a wheel demand torque is smaller than a torque T3 at a time point that does not require a rapid response of a system. In exemplary embodiments, the electric oil pump is controlled to be suitably operated at a first speed (low speed) when the current vehicle speed is equal to the second reference vehicle speed C2 and the wheel demand torque is lower than the torque T3. In other preferred embodiments, the electric oil pump is controlled to be turned off when a predetermined time Tt is passed in a state where a driver does not operate the starter key in the ignition on position IG ON toward a start position ST. In still other preferred embodiments, the electric oil pump is controlled to be driven at the first speed when the starter key is turned to the start position ST by the driver after the predetermined time Tt.

In particular embodiments of the invention, a control for compensating for a rotational speed of the electric oil pump is performed with a compensation coefficient according to an oil temperature by detecting the oil temperature discharged from the electric oil pump. In other particular embodiments, a compensation control for increasing the rotational speed of the electric oil pump is performed when the oil temperature is detected to be lower than a reference temperature, and a compensation control for reducing the rotational speed of the electric oil pump or turning off the electric oil pump is performed when the oil temperature is more than the reference temperature.

The invention also features a vehicle comprising the electric oil pump as described herein. The vehicle, in referred embodiments, is a hybrid electric vehicle.

Reference will now be made in detail to certain preferred embodiments of the present invention, examples of which are illustrated in the drawings attached hereinafter, wherein like reference numerals refer to like elements throughout. The embodiments are described below so as to explain exemplary embodiments of the present invention by referring to the figures.

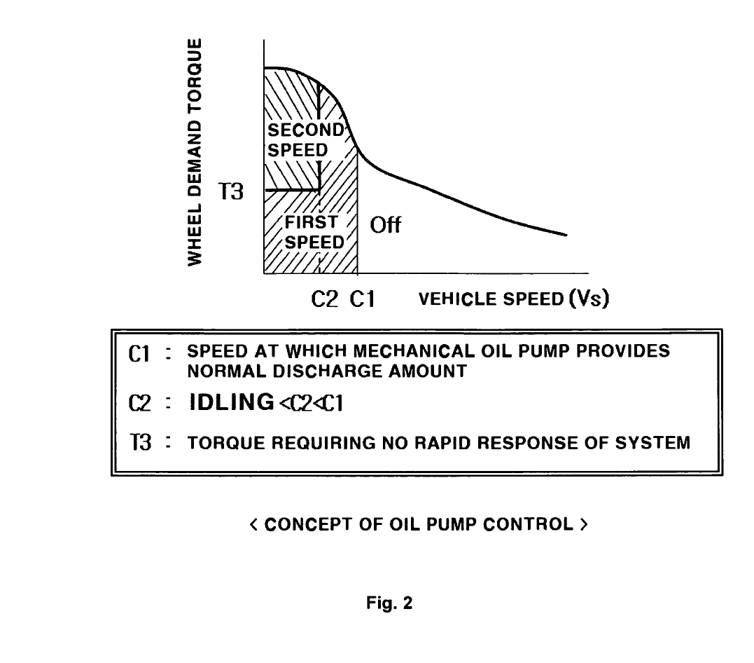

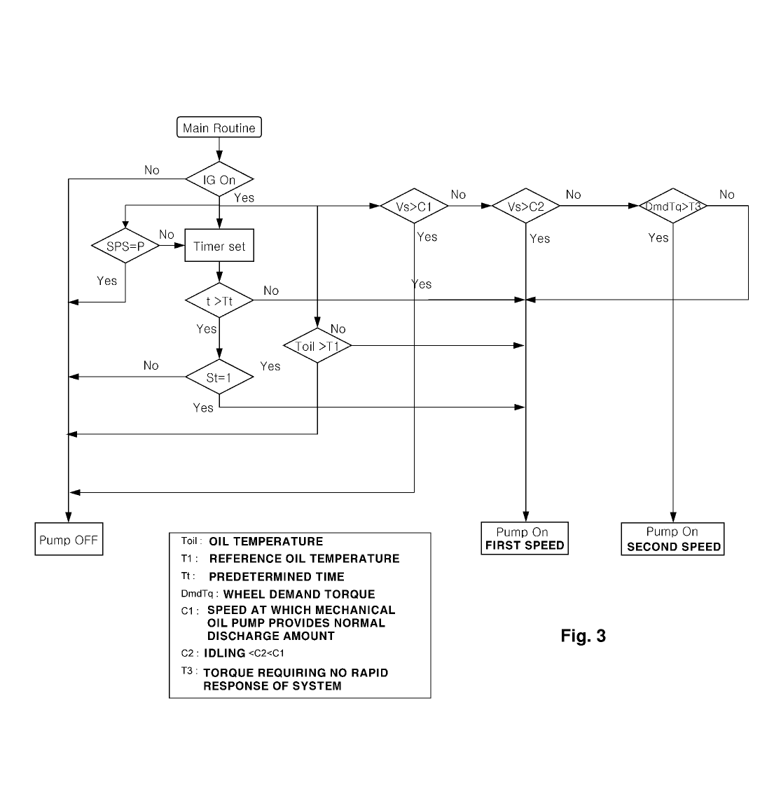

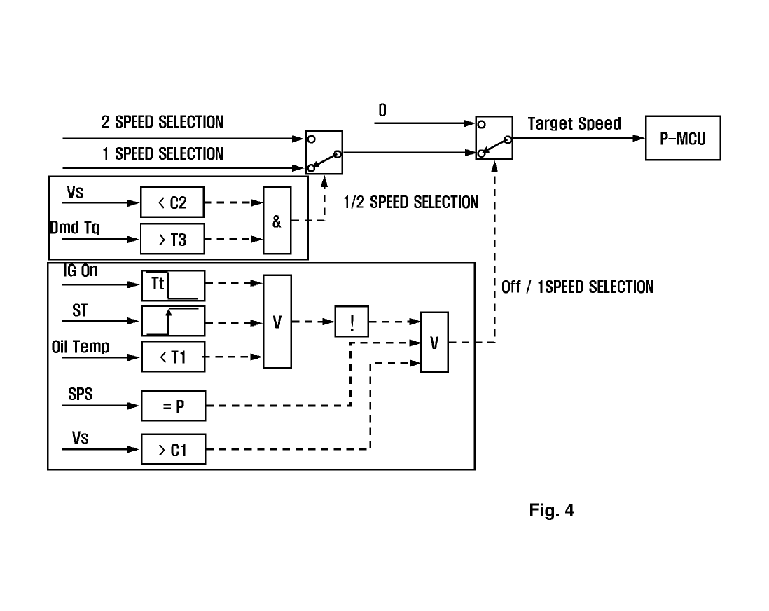

FIG. 2 is a graph illustrating a basic concept of an exemplary method for controlling an electric oil pump for a hybrid electric vehicle in accordance with preferred embodiments of the present invention with respect to a vehicle speed and a wheel demand torque, FIG. 3 is a flowchart, and FIG. 4 is a diagram of an exemplary control algorithm.

In preferred embodiments, the wheel demand torque (DmdTq) may be suitably substituted with a signal according to accelerator depression.

In certain exemplary embodiments, the electric oil pump 60 is turned on in a state where the current vehicle is less than a first reference vehicle speed C1 and a starter key is in an ignition on position IG ON. The rotational speed of the electric oil pump 60 is controlled under the following conditions to provide an efficient power control of the system and satisfy system requirements such as a rapid response. Such a control is suitably made by a hybrid control unit HCU, which is a main controller of the hybrid electric vehicle, or a motor control unit (MCU).

i) In other exemplary embodiments, referring to FIG. 2, the electric oil pump 60 is suitably turned off when the current vehicle speed is preferably more than the first reference vehicle speed C1.

Preferably, the first reference vehicle speed C1 is a speed at which a mechanical oil pump 50 in an automatic transmission 40 provides a normal discharge amount.

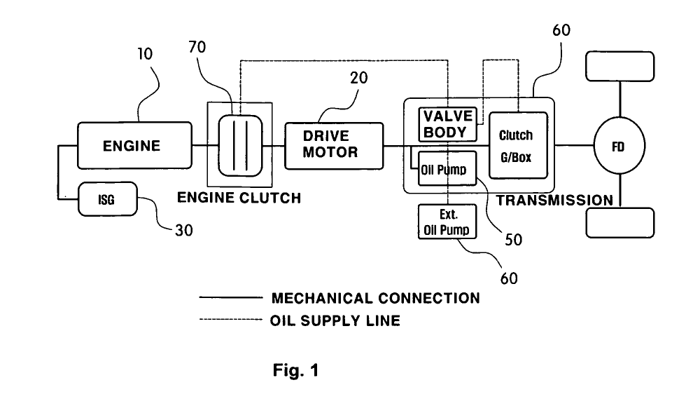

For example, as shown in FIG. 1, since the mechanical oil pump 50 in the automatic transmission 40 that is mechanically connected to a drive shaft can provide a normal discharge amount required in the system when the current vehicle speed is more than a predetermined speed, i.e., the first reference vehicle speed C1, the electric oil pump 60 is suitably controlled to be turned off.

ii) In further exemplary embodiments, the electric oil pump 60 is suitably turned on when the current vehicle speed is less than a predetermined speed, i.e., a second reference vehicle speed C2 that is smaller than the first reference vehicle speed C1. When the current vehicle speed is suitably smaller than the second reference vehicle speed C2 and the wheel demand torque is smaller than a torque T3 at a time point that does not require a rapid response of the system, the electric oil pump 60 is preferably operated at a second speed (high speed) to satisfy the system requirements such as a quick start.

Here, the second reference vehicle speed C2 is suitably a vehicle speed between the first reference vehicle speed C1, which is preferably a time point when the electric oil pump 60 is turned on, and an engine idling state. During the second reference vehicle speed C2, the electric oil pump 60 is preferably turned on.

In other exemplary embodiments, the electric oil pump 60 is operated at a first speed (low speed), which is a relatively low speed.

For example, when the current vehicle speed is suitably equal to the second reference vehicle speed C2 and the wheel demand torque is preferably lower than the torque T3, it is directed to an operation state that does not require a suitably rapid response of the system, and thus the electric oil pump 60 is preferably operated at the first speed (low speed), a relatively low speed. When the current vehicle speed is more than the second reference vehicle speed C2, an oil supply is suitably provided by the mechanical oil pump 50 in the automatic transmission 40, and thus the electric oil pump 60 is turned off. Accordingly, in preferred embodiments it is possible to efficiently control the power that drives the electric oil pump 60.

iii) In other exemplary embodiments, during operation of the system based on the operation of the electric oil pump 60 as described herein, an additional power management compensation and a pump rotational speed compensation with a pump rotational speed compensation coefficient according to an oil temperature are suitably provided.

Preferably, according to the additional compensation during operation of the system, when a predetermined time Tt is passed in a state where a driver does not operate a starter key in the ignition on position IG ON toward a start position ST, the electric oil pump 60 is turned off in terms of the system efficiency.

However, in other preferred embodiments, when the starter key is turned to the start position ST by the driver even after the predetermined time Tt, the electric oil pump 60 is suitably controlled to be driven at the first speed.

In exemplary embodiments, the oil temperature has a significant effect on the viscosity of the oil. Preferably, when the oil temperature is lowered, since the viscosity is increased and thus the flow resistance is increased, the discharge amount is reduced even in the case where the rotational speed of the pump is the same. Accordingly, the compensation coefficient according to the oil temperature discharged from the electric oil pump 60 is suitably introduced to perform a control for compensating for the rotational speed of the electric oil pump 60.

In exemplary embodiments, when the oil temperature is detected to be lower than a reference temperature, a compensation control for increasing the rotational speed of the electric oil pump is suitably performed. In other exemplary embodiments, when the oil temperature is more than the reference temperature, a compensation control for reducing the rotational speed of the electric oil pump or turning off the electric oil pump is suitably performed, thus preventing the electric oil pump from being damaged.

As described herein, the present invention provides the following effects.

It is possible to provide an efficient power control of the system by selectively controlling the electric oil pump, which, in preferred embodiments, uses the electric power of the battery (of high or low voltage) suitably mounted in the vehicle as a power source, at the first speed or the second speed and preferably according to the vehicle speed, the wheel demand torque, and the oil temperature.

In exemplary embodiments of the invention as described herein, it is possible to satisfy the system requirements such as a rapid response by supplying a sufficient amount of oil to the transmission and the engine clutch in case of a quick start after a vehicle stop.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for controlling an electric oil pump for a hybrid electric vehicle, the method comprising:
turning on the electric oil pump when a current vehicle speed is less than a first reference vehicle speed C1, at which a mechanical oil pump in an automatic transmission provides a normal discharge amount, and a starter key is in an ignition on position IG ON;
turning off the electric oil pump when the current vehicle speed is more than the first reference vehicle speed C1, at which the mechanical oil pump in the automatic transmission provides the normal discharge amount; and
controlling the electric oil pump to be turned on at a second reference vehicle speed C2 between the first reference vehicle speed C1, which is a time point when the electric oil pump is turned on, and an engine idling state, and controlling the electric oil pump to be operated at a second speed (high speed) when the current vehicle speed is smaller than the second reference vehicle speed C2 and a wheel demand torque is smaller than a torque T3 at a time point that does not require a rapid response of a system.

2. The method of claim 1, wherein the electric oil pump is controlled to be operated at a first speed (low speed) when the current vehicle speed is equal to the second reference vehicle speed C2 and the wheel demand torque is lower than the torque T3.

3. The method of claim 1, wherein the electric oil pump is controlled to be turned off when a predetermined time Tt is passed in a state where a driver does not operate the starter key in the ignition on position IG ON toward a start position ST.

4. The method of claim 3, wherein the electric oil pump is controlled to be driven at the first speed when the starter key is turned to the start position ST by the driver after the predetermined time Tt.

5. The method of claim 1, wherein a control for compensating for a rotational speed of the electric oil pump is performed with a compensation coefficient according to an oil temperature by detecting the oil temperature discharged from the electric oil pump, in which a compensation control for increasing the rotational speed of the electric oil pump is performed when the oil temperature is detected to be lower than a reference temperature, and a compensation control for reducing the rotational speed of the electric oil pump or turning off the electric oil pump is performed when the oil temperature is more than the reference temperature.

6. A method for controlling an electric oil pump for a hybrid electric vehicle, the method comprising:
turning on the electric oil pump when a current vehicle speed is less than a first reference vehicle speed C1, at which a mechanical oil pump in an automatic transmission provides a normal discharge amount, and a starter key is in an ignition on position IG ON; and
turning off the electric oil pump when the current vehicle speed is more than the first reference vehicle speed C1, at which the mechanical oil pump in the automatic transmission provides the normal discharge amount.

7. The method of claim 6, further comprising controlling the electric oil pump to be turned on at a second reference vehicle speed C2 between the first reference vehicle speed C1, which is a time point when the electric oil pump is turned on, and an engine idling state, and controlling the electric oil pump to be operated at a second speed (high speed) when the current vehicle speed is smaller than the second reference vehicle speed C2 and a wheel demand torque is smaller than a torque T3 at a time point that does not require a rapid response of a system.

8. The method of claim 6, wherein the electric oil pump is controlled to be operated at a first speed (low speed) when the current vehicle speed is equal to the second reference vehicle speed C2 and the wheel demand torque is lower than the torque T3.

9. The method of claim 6, wherein the electric oil pump is controlled to be turned off when a predetermined time Tt is passed in a state where a driver does not operate the starter key in the ignition on position IG ON toward a start position ST.

10. The method of claim 6, wherein the electric oil pump is controlled to be driven at the first speed when the starter key is turned to the start position ST by the driver after the predetermined time Tt.

11. The method of claim 6, wherein a control for compensating for a rotational speed of the electric oil pump is performed with a compensation coefficient according to an oil temperature by detecting the oil temperature discharged from the electric oil pump.

12. The method of claim 11, wherein a compensation control for increasing the rotational speed of the electric oil pump is performed when the oil temperature is detected to be lower than a reference temperature, and a compensation control for reducing the rotational speed of the electric oil pump or turning off the electric oil pump is performed when the oil temperature is more than the reference temperature.
